(19) United States
(12) Patent Application Publication
(10) Pub. No.: US 2009/0236146 A1
(43) Pub. Date: Sep. 24, 2009

(54) MACHINE AND METHOD FOR TRENCHLESS CONDUIT INSTALLATION

(75) Inventor: Stephen J. Pierz, Peoria, IL (US)

Correspondence Address: Caterpillar Inc.;Intellectual Property Dept., AH 9510, 100 N.E. Adams Street, PEORIA, IL, 61629-9510, US

(73) Assignee: CATERPILLAR INC., Peoria, IL (US)

(21) Appl. No.: 12/051,004

(22) Filed: Mar. 19, 2008

(51) Int. Cl. F16L 1/038

(52) U.S. Cl. 175/62; 175/162

(57) ABSTRACT

An improved machine and method of horizontal drilling is disclosed wherein the machine includes a device for producing a continuous length of conduit that surrounds the drill string for simultaneous boring and positioning of the conduit.

### TECHNICAL FIELD

The present disclosure relates generally to earth boring machines and conduit installation, and more specifically, to machines for horizontal directional drilling and simultaneous positioning of continuous lengths of conduit.

### BACKGROUND

Underground conduits are employed for a number of conventional applications. For example, they may be used for transmission of water, natural gas, sewage and other fluids, or they may be used to group and/or protect power transmission and communications cables, such as coaxial and fiber optic cables from water and physical damage.

The usual method of installing underground conduits and cables is to dig a trench, which is back-filled after the conduit is positioned therein. However, there are numerous situations in which this method is undesired, impractical or prohibitively expensive. In certain applications, there may be buildings, bodies of water, roadways and other obstacles that prohibit digging a trench. Even where obstacles can be avoided, ripping up a roadway, existing landscaping, or environmentally sensitive areas may still be undesirable, often increasing project costs and closing the construction area for an extended period of time.

To address these and other concerns, it is known in the art to employ Horizontal Directional Drilling (HDD) methods, which refers to trenchless techniques that allow for the construction of relatively long underground tunnels through which a conduit may then be pushed or pulled. Modern HDD equipment allows the user to construct a tunnel that, within certain limits, may twist and turn to avoid various obstacles, placing the conduit along a desired path. HDD allows a tunnel to be placed with great precision since the location, direction and depth of the drilling head may be controlled and monitored during drilling. A drilling machine is positioned on the drilling surface and a hole drilled at an angle until a desired depth is achieved, after which the cutting or drilling tool is directed along a horizontal path to create the horizontal borehole. The cutting tool/drill head is provided with thrust and/or rotation through motors, electric or hydraulic, which are operatively connected through the drill string, a series of drill rods or pipes that are connected in sequence, end to end, as the bore is formed. Once the desired length of the borehole has been reached, the cutting tool is then directed upwards, back to the surface. A reamer may then be attached to the drill string, which is pulled back through the borehole to remove debris and/or enlarge the bore. A conduit may be connected to the end of the drill string or reamer as it is pulled back through the bore, or the conduit may be positioned in a separate push or pull-back operation. For example, a separate line may be connected to drag the conduit through the well bore for placement thereof. Since ground penetration only occurs at the entrance and termination points, relatively small amounts of surface area are required for implementation, which may result in cost efficiencies, lessening of environmental impact, and other benefits.

An additional problem associated with this operation is that the borehole may be compromised during drilling, pull-back or conduit installation. In some applications, drilling mud may be employed during drilling, which is passed through the drill string and/or drill head back through the bore to remove debris as the cutting tool advances. The drilling mud may form a cake on the walls of the bore to prevent collapse of the bore. However, the use of drilling muds may not be desirable in all applications and may not be fully effective. This may increase difficulties in connection with the pull-back or conduit installation process once the bore is formed, and result in increased cost.

The present disclosure is directed to overcoming one or more of the problems set forth above.

### SUMMARY OF THE INVENTION

In one aspect, the present disclosure provides a method of conduit installation that includes drilling a generally horizontal bore and simultaneously installing a continuous length of conduit.

In another aspect, provided is a drilling machine for horizontal boring and simultaneous conduit installation that includes a conduit forming assembly configured to produce a continuous length of conduit surrounding a drill string.

In yet another aspect, provided is a drilling machine for horizontal boring and simultaneous conduit installation that includes a conduit forming assembly configured to produce a continuous length of conduit surrounding a drill string. The machine further includes a clamping assembly operatively connected to a thrust motor, the clamping assembly configured to engage a portion of the conduit.

These and other aspects and advantages of the present disclosure will become apparent to those skilled in the art upon reading the following detailed description in connection with the drawings and appended claims.

### BRIEF DESCRIPTION OF THE DRAWINGS

FIG. 1 is a side elevational view of a horizontal drilling machine in accordance with one embodiment of the present disclosure;

FIG. 2 is a side elevational view of another embodiment of a horizontal drilling machine in accordance with one embodiment of the present disclosure;

FIG. 3 is a side elevational view of another embodiment of a horizontal drilling machine in accordance with one embodiment of the present disclosure.

### DETAILED DESCRIPTION

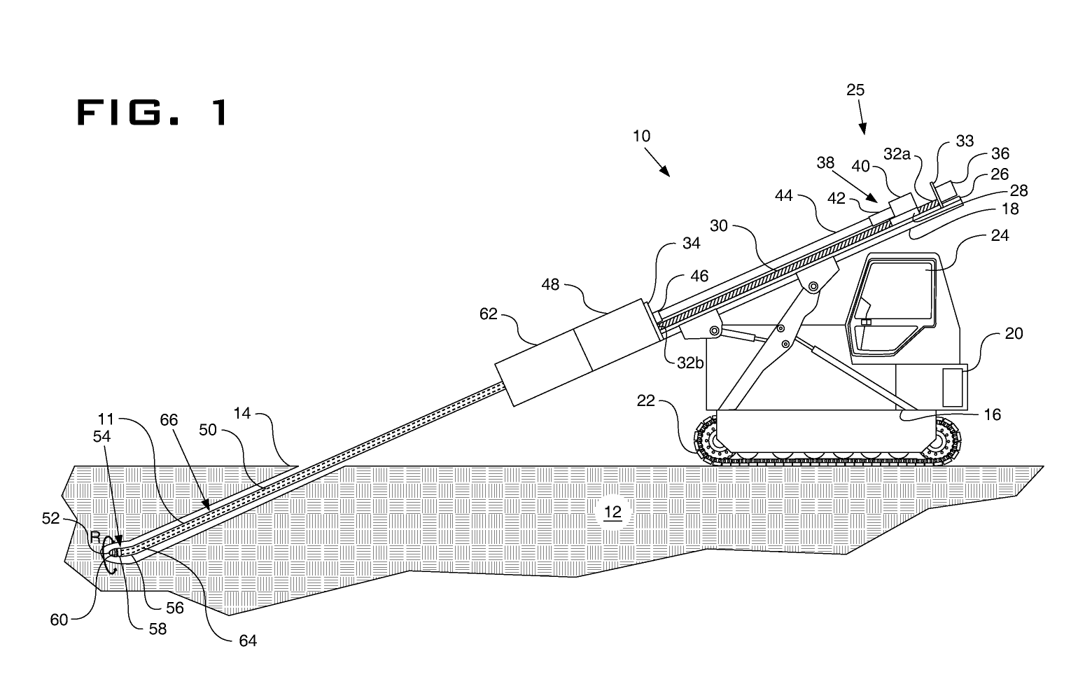

Referring to FIG. 1, there is illustrated one embodiment of a horizontal directional drilling machine (HDD) machine 10 for providing simultaneous drilling and placement of a continuous length of conduit. FIG. 1 illustrates a cross-section through a portion of ground 12 where a horizontal drilling operation takes place. The HDD machine 10 may be positioned on surface 14, however, it may also be positioned below surface 14 in an excavated area (not shown). The HDD machine 10 generally includes a frame 16 on which is positioned an inclined longitudinal support member 18. The machine 10 may be temporarily secured to surface 14 by, for example, ground engaging stakes, pins, or other restraining members (not shown), to prevent the machine 10 from moving during drilling operations.

Machine 10 may include a power source 20 and cooling system (not shown) supported by frame 16. The power source 20, such as a diesel or gasoline engine, may be operatively coupled through a transmission (not shown) to drive one or more traction devices 22 as known in the art. As shown in FIG. 1, traction devices 22 may include tracks disposed on opposing sides of the machine 10. Alternatively, traction devices 22 may include wheels, belts, or other traction devices 22 known in the art. In an alternative embodiment, machine 10 may not include a power source 20 for propulsion, and may need to be positioned by another machine (not shown), such as a tractor, truck, dozer or the like. Machine 10 may also include an operator station or cab 24 for primary control of the machine 10 during ordinary operations.

In one embodiment, a pair of parallel guide tracks 26 are supported in spaced apart configuration on the support member 18. A carriage 28 is mounted for movement along the guide tracks 26 on rollers, wheels or bushings (not shown). Thus, carriage 28 is configured for movement backward and forward along guide tracks 26.

A threaded drive shaft 30 having a first end 32a and second end 32b is connected to front 34 and rear 33 ends of support member 18. A thrust motor 36 is also mounted to the support member 18 and is operatively connected to shaft 30 through a gearbox (not shown) to control the rotational speed and direction of the shaft 30. The thrust motor 36 may be hydraulically or electrically driven as is known in the art. Shaft 30 is connected to carriage 28 via a nut (not shown) or the like such that rotation of the shaft 30 moves the carriage 28 forward or backward linearly along tracks 26.

Drill assembly 38 is mounted to the carriage 28 for movement therewith, and includes a drill motor 40 having a drill rod coupling 42 for releaseably connecting a drill rod 44 to the drill motor 40. The drill rod 44 may include a threaded end (not shown) for rotatably engaging a threaded bore (not shown) of coupling 42, and thus drill motor 40. Again, the drill motor 40 may be hydraulically or electrically powered as known in the art.

A clamping assembly 46 may be mounted to front end 34 of the support member 18. The clamping assembly 46 may include, for example, a central bore (not shown) for receiving rod 44 and clamping members (not shown) for selectively engaging the rod 44 as is known in the art.

As in conventional drilling operations, the rotational/drill motor 40 is initially positioned at upper, first end 32a, and is employed to rotate the rod 44, attached drill string 50 and cutting tool 52. At the same time, the drill assembly 38 is pushed in a forward direction by the thrust motor 36 toward front end 34. Once the drill assembly 38 reaches the front end 34, clamping assembly 46 is engaged to grip the drill string 50 to stop rotation thereof, and to secure the rod 44 for connecting additional rods to the drill string 50. The drill assembly 38 is then uncoupled from the clamped rod 44, and pulled back to an upper position at first end 32a. A new rod 44 is then added to the drill string 50, either manually or automatically. The clamping assembly 46 then releases the drill string 50 and the thrust motor 36 is again employed to drive the new rod 44 into the borehole.

Positioned ahead of the clamping assembly 46 is a conduit forming assembly 48 that is configured to manufacture a continuous length of conduit as the drill string 50 is advanced. This eliminates the need for a separate process, in which, after the bore is drilled, the desired conduit is either pushed or pulled back through the bore.

In one embodiment, the conduit forming assembly 48 may be an extruder for producing either polymeric or metal conduits well known in the art. Such extruders typically consist of a hopper (not shown) for addition and storage of feedstock (chips, pellets, beads, or the like of the base material) which are heated via a heating element (not shown) to a molten form which is forced through a die (not shown) under pressure. At the center of the die may be positioned a pin or mandrel (not shown), configured with a hollow core (not shown) through which the drill string 50 may be fed. Due to the heat that may be involved in the extrusion process, it may be desirable to include a cooling sheath (not shown) surrounding the drill string as it passes through a portion of the forming assembly 48. In one embodiment (not shown), this may include, for example, a cylindrical sleeve that includes passages through which a coolant, such as water or an ethylene glycol solution, is circulated from a pump (not shown) driven by power source 20. In an alternative embodiment, the mandrel may be provided with a cylindrical bore for receiving the drill string 50, the drill string being cooled by drilling fluid that is passed through the bore that then enters the newly formed conduit 11.

In conventional continuous extrusion processes, the extruded material is subsequently cooled by, for example, employing a fluid bath. Moreover, the extrusion process may require that the conduit 11 be cured relatively quickly such that deformation does not occur as the drill string 50 advances. Accordingly, in another embodiment, following the conduit forming assembly 46, provided is a cooling assembly 62 that may include a fluid bath, sprayers, cooling jacket, or combination thereof (not shown). Cooling fluid may be circulated through the bath or cooling jacket by a pump (not shown) operatively connected to power source 20 in a closed fluid circuit that may also include one or more heat exchangers (not shown).

In operation, the extruder may be configured to produce conduit 11 around the pipe string 50 at substantially the same rate as the drill string 50 is moved forward. In one embodiment, the string 50 may be advanced a desired distance, for example, the length of one rod 44, allowing the extruder to produce a corresponding length of conduit 11 that remains in the cooling assembly 62 until sufficiently cured. After the curing time is achieved, the drill string 50 is advanced and the process is repeated.

Operatively connected to the leading end of the drill string 50 is a drilling head or cutting tool 52. The cutting tool 52 is coupled to the drill string 50 for rotation, driven by drill motor 40, and is forced forward via thrust motor 36. The cutting tool 52 may be supplied with a connector 54 for attachment of the leading end 56 of the conduit 11 so that the conduit advances in concert with the cutting tool 52. As shown in FIG. 1, the connector 54 may include a first portion 58 attached to the conduit 11 that can freely rotate with respect to a second portion 60 connected to the cutting tool 52, thereby eliminating torsional stresses that would otherwise be applied to the conduit. In an alternative embodiment, the conduit 11 may be rotated through the extrusion process at substantially the same rate of rotation as the drill string 50, in which case, a rigid connection may be provided.

The disclosed machine 10, is thus adapted to perform a horizontal drilling operation while simultaneously installing a continuous length of conduit. The term “continuous” distinguishes this from conventional processes in which lengths of pipe or tubing are joined end to end, either mechanically, or through a welded connection. This eliminates the separate step of having to join the ends and ensure that the connections are properly fitted or sealed. The term “continuous” also should be understood to refer to operations wherein a relatively short, single length of pipe can be employed, for example, in distances greater than 50 feet. While the above embodiment includes an extrusion process, other techniques well known to those of skill in the art may be employed to produce continuous conduits in accordance with the present disclosure. These may include, for example, centrifugal casting and forming a conduit from a sheet of material that is joined longitudinally.

Thus, in another embodiment, conduit forming assembly 48 may include a continuous centrifugal casting device that generally includes a rotating tubular mold (not shown) into which a molten casting material is introduced. Specific components and methods of cooling the mold, withdrawing the cast tube, bearings, rotational devices, and the like, are well known in the art. Again, the casting process may take place around the drill string 50. That is the drill string 50 may pass through the center of the tubular mold during the casting process. In one embodiment, a protective sheath (not shown) may be provided over the portion of the drill string 50 passing through the mold, which may include a cooling jacket incorporated therein that is fluidly connected to a pump for circulating a cooling fluid to protect the drill string 50 from the heat associated with the casting process. In association with this process a cooling assembly 62 may be provided as discussed previously in connection with the extrusion embodiment, as known in the art.

In yet another embodiment, the conduit forming assembly 48 may instead include a continuous roll of a polymeric or metallic sheet material that is folded and joined along a longitudinal axis about the drill string 50 as it advances through the borehole. For example, the conduit forming assembly 48 may include a roll of sheet HDPE material (not shown) that is passed through a guide member (not shown) that folds the sheet into a tubular form, optionally with the application of heat to the sheet to improve flexibility thereof. The two longitudinal edges of the sheet may then be joined via well known heat-fusion methods. In summary, a heating plate may be applied to the opposing edges under force, the opposing edges then pass the heating plate and force is continually applied to bring the heated edges together, for example, by passing them through a tubular guide. The exterior bead may generally be left intact, while the interior bead may be removed by a blade as the newly formed length of conduit moves forward. This process may result in a fused longitudinal joint that has a strength substantially equivalent to that of the original sheet material. Again, where needed, a subsequent cooling assembly 62 can be employed.

It is well known in the art to employ a drilling fluid or mud, which is typically forced through a hollow interior of a drill string to power the drill head, remove debris from the bore as it is drilled, to provide a smooth bore surface and/or to protect the integrity of the bore prior to placement of a conduit in a subsequent push or pull-back operation. In the embodiment described in FIG. 1, the machine 10 may include a tube (not shown) in fluid connection with a source of drilling fluid/mud (not shown), the tube being fluidly connected to a pump (not shown). The pump may, in turn, be fluidly connected directly or through an output conduit (not shown) to direct a flow of drilling fluid/mud through either the drill string 50 and/or conduit 11. The fluid may exit the drill string 50 or conduit 11 near the leading end 56 thereof (or through the cutting tool 52 or coupling 54) to circulate back through the bore 66, to where it is ultimately dumped into a mud pit (not shown).

In yet another alternative embodiment, cutting tool 52 may be of the type known in the art wherein the drilling mud forced through the drill string 50 or conduit 11 is used to power the drill. It may include a cutting tip, for example of the type known in the art that has multiple rotors each having a plurality of cutting teeth. The drill string 50 may be included for purposes of providing thrust through, for example, thrust motor 36, while the cutting tool 52 is hydraulically driven for rotation.

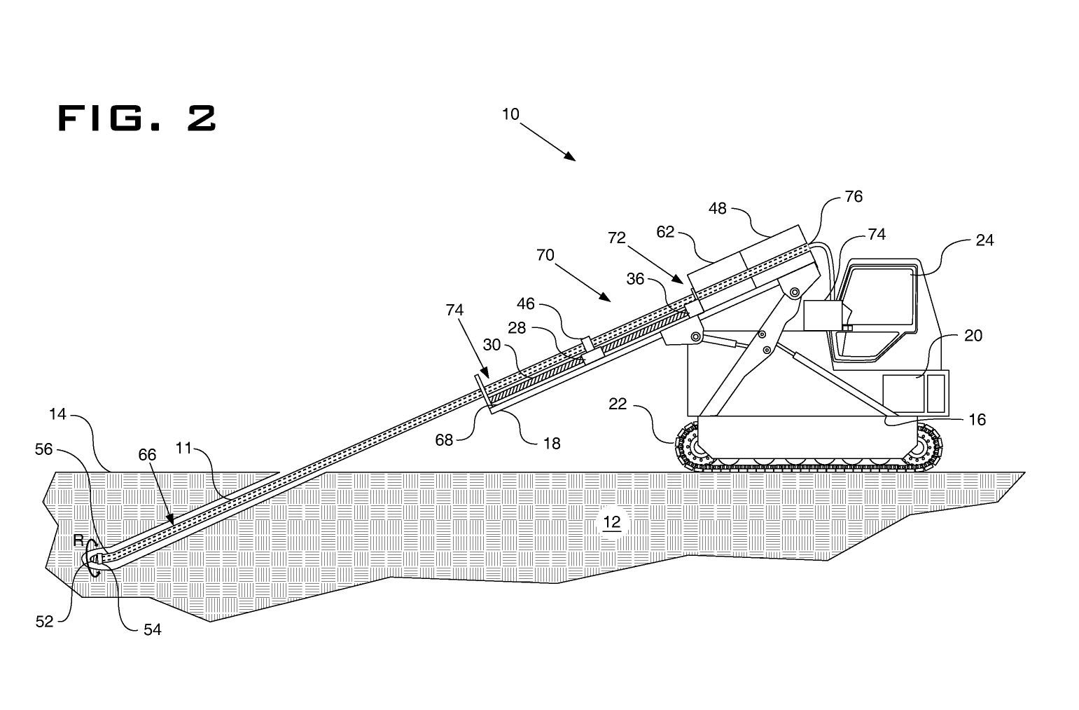

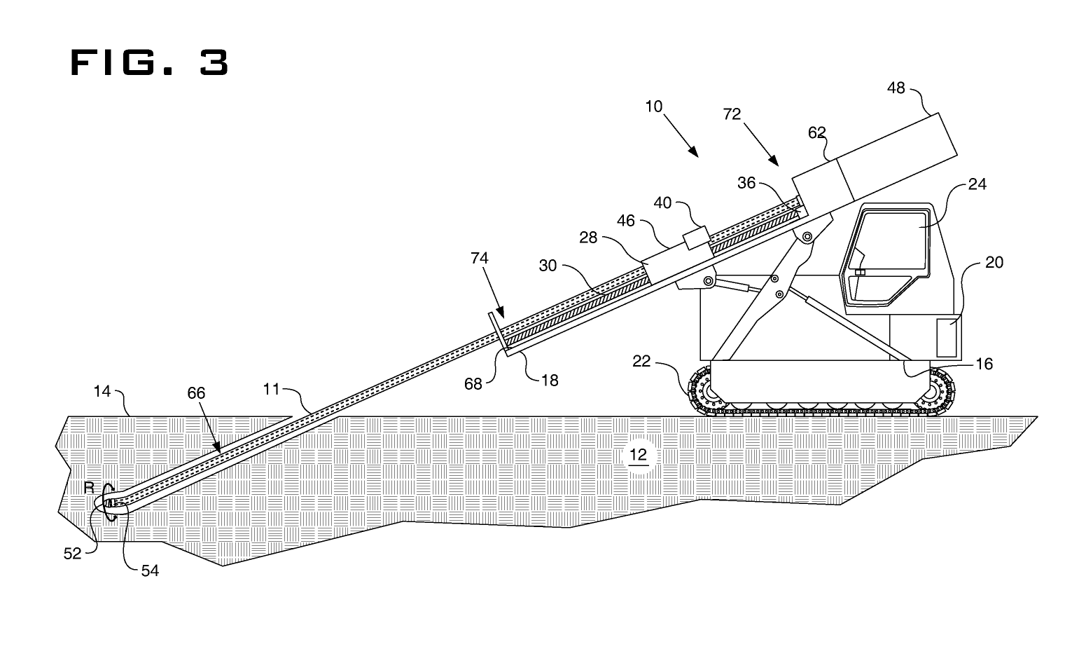

In some applications, the strength of the conduit 11 may be sufficient to eliminate the need for a drill string 50. This is shown, for example, in connection with FIGS. 2-3. In FIG. 2, machine 10 includes a conduit forming assembly 48 and, optionally, a cooling assembly 62 as previously described in connection with FIG. 1 for producing a continuous length of conduit 11.

The machine 10 includes a thrust assembly 70, generally composed of a clamping assembly 46 associated with a carriage 28 that is configured for movement along longitudinal guide rail(s) 68, supported on rollers, wheels or bushings (not shown). A thrust motor 36 mounted to support member 18 is operatively connected to a threaded shaft 30 that drives a threaded receiving member (nut) (not shown) connected to the carriage 28 for movement thereof. In operation, the conduit 11 exits the conduit forming assembly 48 and cooling assembly 62, where it is grasped by clamping assembly 46. Thrust motor 36 is then engaged to drive carriage 28 from first position 72 toward second, downward position 74 at substantially the same rate as the newly formed conduit 11 exits the extruder.

In an alternative embodiment, where the length of time required for curing the conduit 11 exceeds the minimum required time before the conduit 11 can be advanced without distorting or otherwise compromising the integrity thereof, there may be a curing interval provided. For example, a first length of conduit, for example, the length of the guide rail 68, may be produced, and allowed to cool. A second length of conduit 11 may then be produced, and the first length advanced to position 74, wherein the cutting tool 52 may be coupled thereto via a connector 54. At the same time, the clamping assembly 46 may be moved to the upper position 72, and engaged to grasp the first length of conduit 11. When the second length of conduit has sufficiently cooled (the curing interval), the thrust motor may then be actuated to drive conduit 11 forward.

In the embodiment shown in FIG. 2, the cutting tool 52 is hydraulically driven for rotation via a drilling fluid/mud that is provided via a pump 78 through supply conduit 76 and into open rear end of conduit 11. The supply conduit 76 may extend a distance into conduit 11 to where the conduit 11 is sufficiently cured to be able to withstand the fluid pressure, a seal (not shown) being provided between the interior surface of the conduit 11 and the supply conduit 11. Drilling fluid passes through conduit 11, exiting through cutting tool 52, and returns via the bore 66. Thus, the drilling fluid/mud is employed in a conventional manner to drive the cutting tool 52, carry debris to the surface and/or coat the interior of the bore 66. The drilling fluid may also be employed as part of the cooling strategy for the newly formed conduit 11.

In an alternative embodiment, shown in FIG. 3, the conduit 11 is employed to impart both rotation and thrust for the cutting tool 52. The machine 10 is generally the same as that described in connection with FIG. 2, except that a drill motor 40 is provided for rotation of the clamping assembly 46 as the carriage 28 is moved from first position 72 to second position 74. The speed of rotation imparted by the drilling motor 40 may be substantially the same as the speed of rotation of the newly formed conduit 11 as it exits conduit forming assembly 48.

While aspects of the present disclosure have been particularly shown and described with reference to the embodiments above, it will be understood by those skilled in the art that various additional embodiments may be contemplated without departing from the spirit and scope of what is disclosed. Such embodiments should be understood to fall within the scope of the present invention as determined based upon the claims below and any equivalents thereof.

### INDUSTRIAL APPLICABILITY

In conventional horizontal directional drilling and conduit installations, the drilling operation is conducted first, the conduit being installed in a subsequent push or pull-back operation. The drilling operation typically employs connecting and advancing a series of rods or pipes, connected either through threaded connections or fasteners, that form the drill string, at the leading end of which is the cutting tool. Once the drilling operation is complete, a conduit may be attached to the leading end of the drill string and pulled back through the bore for positioning. Alternatively, the conduit may be attached to a reamer or cable in a subsequent push or pull-back operation.

The present disclosure provides machines for horizontal drilling operations that simultaneously drill the bore and position the conduit. The machines include a conduit forming assembly, such as an extruder, centrifugal casting, or other device, that produces a continuous length of conduit that is connected at a leading end to the cutting tool, thereby eliminating the need for a separate conduit positioning operation, which may decrease costs and project time, as well as provide other benefits. Moreover, because the conduit is formed in a continuous length, it alleviates problems associated with the integrity of joints in conduits formed of adjoining segments.

Other aspects, objects, and advantages of the present disclosure can be obtained from a study of the drawings, disclosure and the appended claims.

What is claimed is:

1. A method of conduit installation comprising drilling a generally horizontal bore and simultaneously installing a continuous length of conduit.

2. The method of claim 1, further comprising the step of drilling a pilot bore prior to drilling the horizontal bore.

3. The method of claim 1, wherein drilling the bore includes the step of advancing a drill string, the continuous length of conduit being formed around the drill string.

4. The method of claim 3, wherein the conduit is formed via extrusion or centrifugal casting.

5. The method of claim 3, wherein the conduit is formed of a continuous sheet that is joined longitudinally as the drill string advances.

6. The method of claim 3, wherein the drill string is operatively connected to a cutting tool, and the drill string is rotated as the drill string advances to rotate the cutting tool.

7. The method of claim 6, wherein the conduit is rotated along with the drill string.

8. The method of claim 3, wherein a drilling fluid is directed through the conduit during drilling.

9. The method of claim 1, further comprising operatively connecting a cutting tool to a leading end of the length of conduit and advancing the conduit to drive the cutting tool.

10. The method of claim 9, wherein the conduit is formed via extrusion or centrifugal casting.

11. The method of claim 9, wherein a drilling fluid is directed through the conduit during drilling.

12. A drilling machine for horizontal boring and simultaneous conduit installation, comprising a conduit forming assembly configured to produce a continuous length of conduit surrounding a drill string.

13. The drilling machine of claim 12, wherein the conduit forming assembly includes an extruding or centrifugal casting apparatus.

14. The drilling machine of claim 13, wherein the machine further comprises a framework having a longitudinal guide track and a carriage disposed for movement along the guide track, a drill motor connected to the carriage and operatively connected to a first end of the drill string.

15. The drilling machine of claim 12, further comprising a cutting tool operatively connected to a leading end of the drill string and conduit.

16. The drilling machine of claim 15, wherein the cutting tool is connected to the conduit by a connector, the connector having a first portion connected to the cutting tool and a second portion connected to the conduit, wherein the first and second portions are rotatably connected.

17. The drilling machine of claim 12, further comprising a pump fluidly connected to the conduit.

18. A drilling machine for horizontal boring and simultaneous conduit installation, comprising:
a conduit forming assembly configured to produce a continuous length of conduit surrounding a drill string;
a clamping assembly operatively connected to a thrust motor, the clamping assembly configured to engage a portion of the conduit.

19. The drilling machine of claim 18, further comprising a pump fluidly connected to the conduit to supply a drilling fluid along the conduit to actuate a cutting tool.

20. The drilling machine of claim 18, further comprising a drill motor operatively connected to the conduit for rotation thereof, a cutting tool operatively connected to a leading end of the conduit.
